(19) United States
(12) Patent Application Publication
(10) Pub. No.: US 2025/0154754 A1
(43) Pub. Date: May 15, 2025

(54) CLIP DEVICE FOR SECURING A SINK TO A WORKTOP

(71) Applicant: Inter IKEA Systems B.V., Delft (NL)

(72) Inventor: Jonas Josefsson, Jonkoping (SE)

(21) Appl. No.: 18/836,347

(22) PCT Filed: Feb. 3, 2023
(86) PCT No.: PCT/SE2023/050089

§ 371 Date: Aug. 6, 2024

(30) Foreign Application Priority Data
Feb. 7, 2022 (SE) 2250116-7

(51) Int. Cl. E03C 1/33

(52) U.S. Cl. CPC E03C 1/335

(57) ABSTRACT

A clip device for securing a sink to a worktop is disclosed. The clip device is adapted for being connected to the sink. The clip device includes a moveable clip that is adapted for engagement with the worktop. The clip device is adapted to move between a non-operational position where the clip is prevented from engagement with the worktop and an operational position where the clip is allowed to engage with the worktop. The clip is in a retracted state in the non-operational position and in an extended state in the operational position. The clip includes two peripheral straight edge surfaces defining a first end stop in a first direction corresponding to the non-operational position and a second end stop in a second direction opposite the first direction corresponding to the operational position.

### CROSS-REFERENCE TO RELATED APPLICATION

This application claims priority to International Patent Application No. PCT/SE2023/050089 filed Feb. 3, 2023, which also claims priority to Swedish Patent Application SE 2250116-7 filed Feb. 7, 2022, the contents of each of which is hereby incorporated by reference in its entirety.

### TECHNICAL FIELD

The invention relates to a clip device for securing a sink to a worktop. The invention further relates to a sink arrangement comprising a sink and a plurality of clip devices for securing the sink to a worktop.

### BACKGROUND

It is known to assemble the sink from above in relation to the worktop. The sink comprises a container and a rim extending around the container. The worktop is provided with an opening for receipt of the container, wherein the opening is sized so that the rim may rest on top of the worktop adjacent the opening.

According to prior art, the sink may be secured to the worktop via a plurality of clips. The sink is therefore provided with a plurality of connection means, in the form of brackets, that are distributed around a periphery of the sink below the rim and rigidly attached to the rim. Each one of the connection means has an opening with a wider section and a narrow section for receipt of an end portion of a screw. Further, the clip has a threaded through-hole, which is adapted to receive the screw. During assembly, in a first step, the sink is lowered from above to its intended position with the container received in the opening of the worktop so that the connection means are accessible from below. In a second step, the screw with the clip is arranged at the connection means in a non-operational position. More specifically, the end portion of the screw is received in the wider section of the through-hole of the connection means and moved transversally to its extension direction to the narrow section so that the screw hangs from the connection means. In a third step, a tool is engaged from below with a head of the screw and by rotating the screw, the clip is moved upwards along the screw towards an operational position in engagement with a lower surface of the worktop.

It may however be cumbersome to assemble the sink in the way described above. Especially, it requires an operator to be positioned below the sink in a way that he may locate the connection means and arrange each one of the screws in connection with a respective one of the connection means. Further, since the screw hangs freely from the connection means, there is a risk that the screw falls out of the connection means after positioning. Further, the assembly requires monitoring that the clip ends up in the correct orientation during rotation of the screw for a secure arrangement of the sink relative to the worktop.

### SUMMARY

A first object of the invention is to provide a clip device that creates conditions for a facilitated assembly.

The object is achieved by a device according to claim 1. Thus, it is achieved by a clip device for securing a sink to a worktop, wherein the clip device is adapted for being connected to the sink and comprises a clip that is adapted for engagement with the worktop, wherein the clip device is adapted for movement of the clip between a non-operational position and an operational position, characterized in that the clip is in a retracted state in the non-operational position and in an extended state in the operational position, that the clip device is adapted for maintaining the clip in the non-operational position so that the clip device may be connected to the sink during movement of the sink towards a desired position relative to an opening of the worktop and that the clip device is adapted for movement of the clip from the non-operational position towards the operational position when the sink is in the desired position relative to the worktop.

According to one aspect a clip device is provided. The clip device is configured to secure a sink to a worktop. The clip device comprises a support structure and a clip being rotatable relative the support structure from a non-operational position, in which the clip is in a retracted position in relation to the support structure, to an operation position, in which the clip is an extended position in relation to the support structure. The clip comprises peripheral edge surfaces defining a first stop position for the clip corresponding to the non-operational position, and a second stop position for the clip corresponding to the operational position.

According to one example, the clip is arranged in such a way in the retracted state that an engagement portion of the clip is proximate to the sink container. According to one further example, the clip is arranged in such a way in the extended state that its engagement portion is distant from the sink container. Thus, in order for the engagement portions of the clips to engage with a surface of the worktop adjacent the opening, the engagement portions project outwards in a direction from the sink container in the extended state to such an extent that they may engage the surface of the worktop adjacent the opening.

Thus, the clip device is adapted for maintaining the clip in the retracted state, which reduces the risk that the clip may collide with the worktop during lowering of the sink from above into the opening of the worktop. Thus, it creates conditions for arranging the clip device at the sink before the sink is put in place relative to the worktop. Thanks to this arrangement, there is no need for assemblying the screws to the worktop from underneath the sink after positioning of the sink to the worktop.

According to one embodiment example, the clip device defines a first end stop in a first direction corresponding to the non-operational position and a second end stop in a second direction opposite the first direction corresponding to the operational position. It creates further conditions for a facilitated assembly in that it gives an operator an improved guiding when operating the clip device for tightening the clip to the worktop.

According to one further embodiment example, the non-operational position and the operational position are angularly spaced, wherein the clip is arranged to be pivoted between the non-operational position and the operational position. It creates further conditions for a facilitated assembly in that the clip device may comprise a screw and an operator may simply rotate the screw.

According to one further embodiment example, the non-operational position and the operational position are angularly spaced by about 90°.

According to one further embodiment example, the clip device is adapted to guide the clip from the non-operational position via a first pivoting motion to the operational position followed by movement along a straight line with the clip in the operational position for engagement with the worktop. It creates further conditions for a facilitated assembly in that it gives an operator an improved guiding when operating the clip device for tightening the clip to the worktop.

According to one further embodiment example, the clip device comprises a screw adapted for moving the clip between the non-operational position and the operational position, wherein the clip has a threaded through-hole adapted for engagement with threads of the screw. The screw provides for a cost-efficient manufacturing of the clip device and a facilitated assembly.

According to one further embodiment example, the clip comprises a first leg and a second leg extending at an angle relative to the first leg, wherein the first leg of the clip has the threaded through-hole adapted for engagement with the screw and wherein a free end of the second leg has an engagement portion adapted for engagement with the worktop. According to one example, the clip may be formed in one piece. Further, the legs of the clip may be plate-shaped. More specifically, a single piece of plate material may be bent to a desired shape. The first leg and the second leg may be arranged perpendicularly relative to one another. Further, the free end of the second leg may be formed by an edge of the plate-like leg. Further, the engagement portion may form a pointy section of the free end.

According to one further embodiment example, the first leg of the clip has two peripheral straight edge surfaces arranged at an angle relative to one another adjacent the through-hole and a rounded peripheral edge surface connecting the two peripheral straight edge surfaces, wherein the two peripheral straight edge surfaces define the end stops. According to one example, the two peripheral straight edge surfaces may be arranged perpendicularly relative to one another. Further, the rounded peripheral edge surface may have the shape of a circular arc. It provides for a cost-efficient manufacturing of the clip device.

According to one further embodiment example, the clip device comprises a support structure for connection to the sink, wherein a contact surface of the clip is adapted for engagement with a corresponding contact surface of the support structure for maintaining the clip in the non-operational position via friction between the contact surfaces. It creates conditions for securely maintaining the clip in the retracted state and, when desired, moving the clip towards its extended state by overcoming the friction. According to one example, the clip is positioned in the retracted state during manufacturing of the clip device, wherein the clip, due to the friction, will still be in the retracted state when an end user/operator will use it for assembly of the sink.

According to one further embodiment example, the support structure comprises two spaced support members and a spacer member that connects the two spaced support members, wherein each support member has a through hole, which are in line with each other, wherein the screw is freely rotatably arranged in the through-holes and wherein the clip is movably arranged between the two spaced support members. According to one example, the two spaced support members may be arranged in parallel with each other. Further, the spacer member may have a straight orientation and may extend perpendicularly to the two spaced support members. According to one further example, the support structure may be formed in one piece. Further, the two spaced support members and the spacer member may be plate-shaped. More specifically, a single piece of plate material may be cut and bent to a desired shape forming the two spaced support members and the spacer member.

According to one further embodiment example, the spacer member comprises a contact surface facing the clip and wherein the clip is arranged so that pivoting of the clip in one direction is stopped by one of the two peripheral straight edge surfaces contacting the contact surface of the spacer member and pivoting of the clip in the other direction is stopped by the other one of the two peripheral straight edge surfaces contacting the contact surface of the spacer member. It creates conditions for a proper guiding of the clip during the tightening operation of the clip.

According to one further embodiment example, the first leg of the clip has the contact surface and a first one of the two spaced support members has the corresponding contact surface for maintaining the clip in the non-operational position via friction between the contact surfaces. It creates further conditions for a cost-efficient manufacturing of the clip device.

According to one further embodiment example, the clip device comprises a projection, which may be formed by a hook, for connection to a hole in the sink so that the clip device may hang from the sink. It creates conditions for a secure arrangement of the clip device relative to the sink so that the sink may be put in place relative to the worktop with the clip devices hanging from the rim of the sink.

According to a further aspect, the invention regards a sink arrangement. A further object of the invention is therefore to provide a sink arrangement that creates conditions for a facilitated assembly.

The object is achieved by a device according to claim 14. Thus, it is achieved by a sink arrangement for securing a sink to a worktop, wherein the sink arrangement comprises a sink, which comprises a plurality of connection means distributed around a periphery of the sink, and a plurality of clip devices according to any one of the examples and embodiment examples indicated above, wherein connection means of each one of the plurality of clip devices is adapted for connection to one of the plurality of connection means of the sink, wherein an engagement portion of the clip for engagement with the worktop is in the retracted state proximate to the sink and in the extended state distant to the sink.

According to one embodiment example, the sink comprises a container and a rim extending around the container, wherein the clip devices are adapted to be connected to the sink below the rim with the clip in the non-operational position in such a way that the engagement portions of the clips are spaced from a peripheral edge of the rim seen from above so that the sink may be lowered into an opening in the worktop while the clip devices are connected to the sink.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1A is a perspective view of a clip device according to a first embodiment from a first side,

FIG. 1B is a perspective view of a clip comprised in the clip device in FIG. 1,

FIG. 1C is a perspective view of the clip device in FIG. 1A from a second side,

FIG. 2A is a perspective view of a sink arrangement according to a first embodiment,

FIG. 2B and FIG. 2C are perspective views of the clip device in FIG. 1A in consecutive assembly steps,

FIG. 3A and FIG. 3B are perspective views of a sink comprised in the sink arrangement in FIG. 2A and a worktop in consecutive assembly steps, and

FIGS. 4A, 4B, 4C and 4D are perspective views of the clip device in FIG. 1A in consecutive assembly steps relative to the sink and worktop in FIG. 3B.

### DETAILED DESCRIPTION

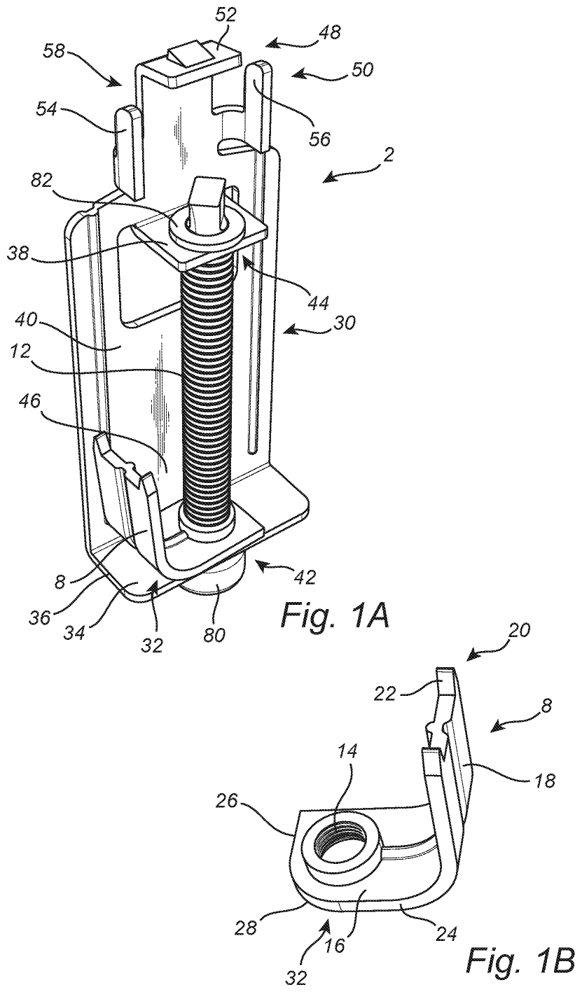

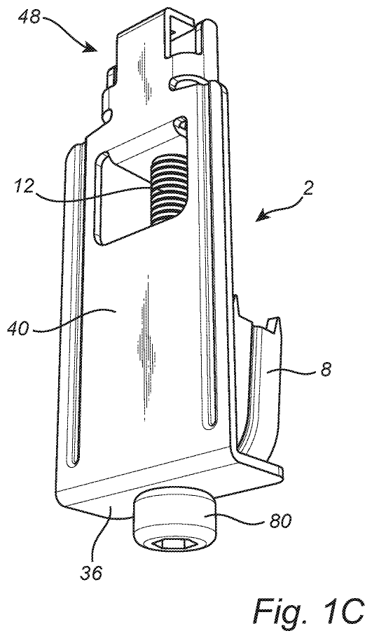

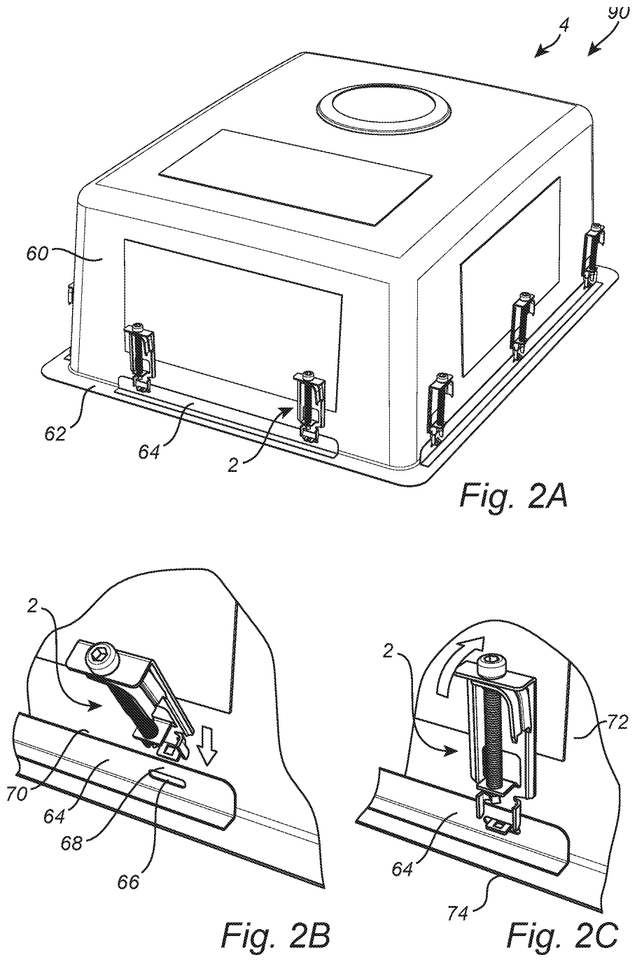

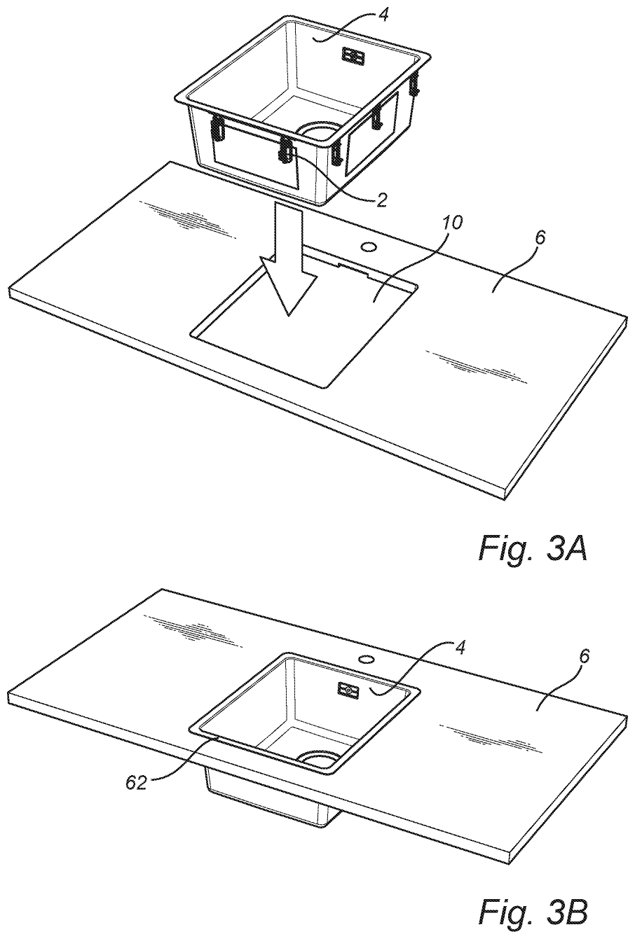

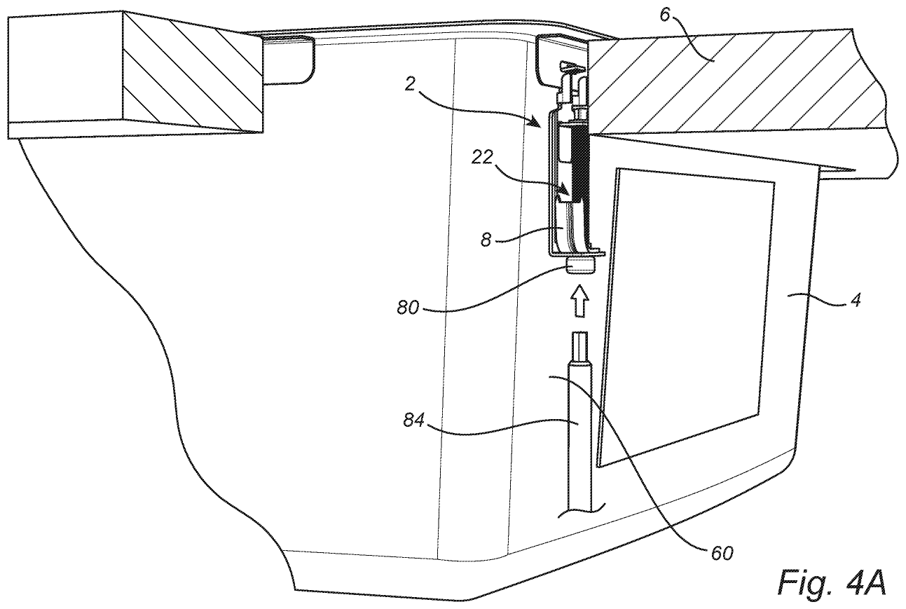

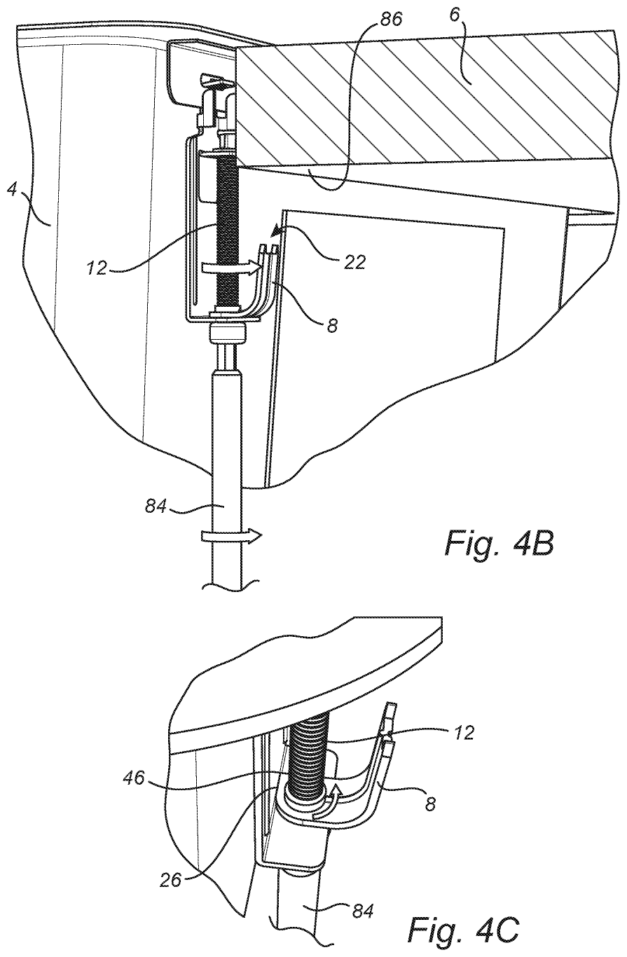

FIG. 1A and FIG. 1C are perspective views of a clip device 2 according to a first embodiment from two different sides. The clip device 2 is adapted for securing a sink 4 to a worktop 6, see FIGS. 2A and 3A. The clip device 2 is adapted for being connected to the sink 4 and comprises a clip 8 that is adapted for engagement with the worktop 6. The worktop 6 is in this case formed in a relatively soft material and more particularly in wood. The clip 8 may be formed in a metallic material. The clip device 2 is adapted for movement of the clip 8 between a non-operational position and an operational position. The clip 8 is in the non-operational position in FIG. 1A. More specifically, the clip 8 is in a retracted state in the non-operational position.

The clip device 2 is adapted for maintaining the clip 8 in the non-operational position so that the clip device 2 may be connected to the sink 4 during movement of the sink 4 towards a desired position relative to an opening 10 of the worktop 6, see FIG. 3A. Thus, the clip device 2 is adapted for maintaining the clip 8 in the retracted state, which reduces the risk that the clip 8 may collide with the worktop 6 during lowering of the sink 4 from above into the opening 10 of the worktop 6. Thus, it creates conditions for arranging the clip device 2 in connection with the sink 4 before the sink 4 is put in place relative to the worktop 6.

The clip device 2 comprises a screw 12 adapted for moving the clip 8 between the non-operational position and the operational position. The clip 8 has a threaded through-hole 14, see FIG. 1B, adapted for engagement with threads of the screw 12.

The clip 8 comprises a first leg 16 and a second leg 18 extending perpendicularly relative to the first leg 16, see FIG. 1B. The first leg 16 of the clip 8 has the threaded through-hole 14 adapted for engagement with the screw 12 and wherein a free end 20 of the second leg 18 has an engagement portion 22 adapted for engagement with the worktop 6. More specifically, the engagement portion 22 forms two spaced pointy sections of the free end 20 adapted for penetrating the material of the worktop. Further, the clip 8 is formed in one piece. Further, the legs 16, 18 of the clip 8 are plate-shaped.

Further, the first leg 16 of the clip has two peripheral straight edge surfaces 24, 26 arranged perpendicularly relative to one another adjacent the through-hole 14 and a rounded peripheral edge surface 28 connecting the two peripheral straight edge surfaces 24, 26. The rounded peripheral edge surface 28 has the shape of a circular arc. The two peripheral straight edge surfaces 24, 26 define a first end stop in a first direction corresponding to the non-operational position and a second end stop in a second direction opposite the first direction corresponding to the operational position.

The clip device 2 comprises a support structure 30 for connection to the sink 4. A contact surface 32 of the clip 8 is adapted for engagement with a corresponding contact surface 34 of the support structure 30 for maintaining the clip 8 in the non-operational position via friction between the contact surfaces 32, 34.

The support structure 30 comprises two spaced support members 36, 38 and a spacer member 40 that connects the two spaced support members 36, 38. Each support member 36, 38 has a through hole 42, 44, which are in line with each other. The screw 12 is freely rotatably arranged in the through-holes 42, 44. Further, the clip 8 is movably arranged along the screw 12 between the two spaced support members 36, 38. The two spaced support members 36, 38 are arranged in parallel with each other. Further, the spacer member 40 has a straight orientation and extends perpendicularly to the two spaced support members 36, 38. More specifically, the clip device 2 is adapted so that the screw 12 extends in parallel with an extension direction of the spacer member 40. More specifically, the support structure 30 is formed in one piece. Further, the two spaced support members 36, 38 and the spacer member 40 are plate-shaped. The first support member 36 is formed by a bent end piece of the spacer member 40 and the second support member 38 is formed by a cut-out from the spacer member 40.

The spacer member 40 comprises a contact surface 46 facing the clip 8 and wherein the clip 8 is arranged so that pivoting of the clip 8 in one direction is stopped by one of the two peripheral straight edge surfaces 24, 26 contacting the contact surface 46 of the spacer member 40 and pivoting of the clip 8 in the other direction is stopped by the other one of the two peripheral straight edge surfaces 24, 26 contacting the contact surface 46 of the spacer member 40. It creates conditions for a proper guiding of the clip 8. During pivoting of the clip 8 between the non-operational position and the operational position, the rounded peripheral edge surface 28 may be in continuous contact with the associated contact surface 46 of the spacer member 40.

Further, the first leg 16 of the clip 8 has the contact surface 32 and a first one 36 of the two spaced support members has the corresponding contact surface 34 for maintaining the clip in the non-operational position via friction between the contact surfaces.

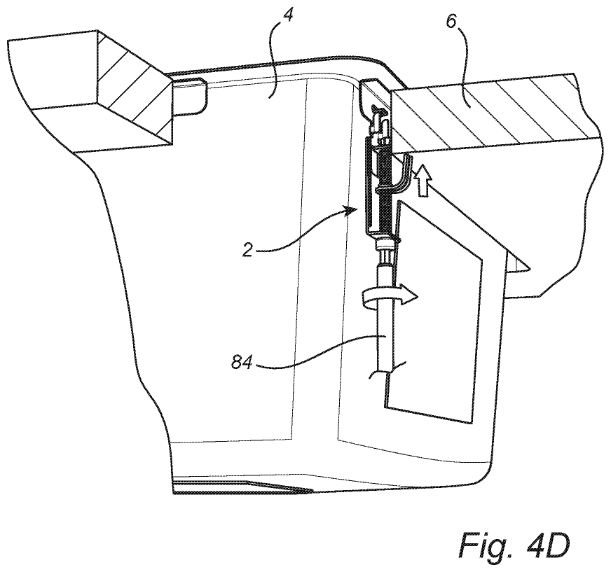

The screw 12 comprises a head 80 configured for engagement with a tool 84, see FIG. 4A. The screw 12 is oriented so that the head 80 is positioned on an opposite side of the first support member 36 relative to the clip 8. The screw head 80 has a larger transverse extension than the hole 42 in the first support member 36. Further, a plate-shaped ring 82 is arranged at an opposite end of screw in its longitudinal direction relative to the screw head 80. The plate-shaped ring 82 is positioned on an opposite side of the second support member 38 relative to the clip 8. The plate-shaped ring 82 has a larger transverse extension than the hole 44 in the second support member 38. The plate-shaped ring 82 is connected to the screw 8 in a way allowing free rotation of the screw 8 in the hole 44 in the second support member 38.

Further, the clip device 2 comprises a connection means 48 for connection to a hole 66 in the sink 4, see FIG. 2B, so that the clip device 2 may hang from the sink 4. More specifically, the support structure 30 comprises the connection means 48. The connection means 48 is formed at an end 50 of the spacer member 40 in a longitudinal direction of the screw 12 adjacent the second support member 38. More specifically, the connection means 48 is formed in one piece with the spacer member 40. More specifically, the connection means 48 comprises a projection 52 in the form of a hook. More specifically, the connection means 48 comprises a plate-shaped portion arranged perpendicularly relative to the extension direction of the spacer member 40. Further, the connection means 48 comprises two support portions 54, 56, one on each side of the projection 52 in a transverse direction of the spacer member 40, wherein a reception 58 is formed between the projection 52 and the two support portions 54, 56.

The sink 4 is shown in an upside-down state in FIG. 2A. The sink comprises a container 60, which in this case has a rectangular cross section and a rim 62 extending around the container. An elongated L-shaped bracket 64 is rigidly attached to the rim 62, such as via welding. The elongated L-shaped bracket 64 extends along a straight line. The elongated L-shaped bracket 64 comprises a plurality of through holes 66, see FIG. 2B, arranged in a spaced relationship in the longitudinal direction of the elongated L-shaped bracket 64. Each one of the through-holes 66 has an elongated shape extending in parallel with the longitudinal direction of the elongated L-shaped bracket 64. More specifically, each one of the through-holes 66 is adapted for receipt of the projection 52 of the connection means 48 of one of said clip devices 2.

More specifically, a plurality of elongated L-shaped brackets 64 are attached to the rim 64. In the shown example, four elongated L-shaped brackets 64 are attached to the rim 64, one along each side of the rectangular rim 62. Further, clip devices 2 are connected to each one of said brackets 64 in a similar way as has been described above.

The clip device 2 is connected to the sink 4 in a two-step procedure, see FIGS. 2B and 2C. More specifically, the clip device 2 is moved towards the through-hole 66 in an inclined orientation so that the projection 52 may enter the through-hole 66, wherein a portion 68 of the elongated L-shaped bracket 64 between the through-hole 66 and a free end 70 of the bracket is received in the reception 58 defined between the projection 52 and the two support portions 54, 56, see FIG. 2B. When the projection 52 has been received in the through-hole 66, the clip device 2 is pivoted to a position in proximity to a wall 72 of the sink container 60, see FIG. 2C. The clip device 2 is now in an upright position relative to the rim of the sink 4. Thanks to the design of the projection 52 and the two support portions 54, 56, the clip device 2 may be maintained in connection with the sink 4 when the sink is turned around in a next step.

Further, the clip device 2 is connected to the sink 4 with the clip 8 in the non-operational position in such a way that the engagement portion 22 of the clip 8 is spaced from a peripheral edge 74 of the rim 62 seen from above. Thus, the sink 4 may be turned around and lowered into the opening 10 in the worktop 6 while the clip devices 2 are connected to the sink 4, see FIG. 3A. In FIG. 3B, the sink 4 is positioned in the opening 10 in the worktop 6 in a way that the rim 62 rests on an upper surface of the worktop 6 adjacent the opening 10.

FIGS. 4A, 4B, 4C and 4D are perspective views of the clip device 2 in consecutive assembly steps relative to the sink 4 and worktop 6, seen from below the worktop 6. In a first step, a tool 84 is moved from below to engagement with the screw head 80, see FIG. 4A. The clip 8 is arranged in such a way in the retracted state that the engagement portion 22 of the clip 8 is proximate to the sink container 60.

In a second step, the tool 84 is rotated while being in engagement with the screw head 80, see FIG. 4B. The clip 8 is then moved from its retracted state in the non-operational position to an extended state in the operational position. The clip 8 is arranged in such a way in the extended state that its engagement portion 22 is distant from the sink container 60. More specifically, the engagement portion 22 project outwards in a direction from the sink container 60 in the extended state to such an extent that it may engage a surface 86 of the worktop 6 adjacent the opening 10.

The non-operational position and the operational position are angularly spaced, wherein the clip 8 is arranged to be pivoted between the non-operational position and the operational position. More specifically, the non-operational position and the operational position are angularly spaced by about 90°.

More specifically, the clip device 2 is adapted to guide the clip 2 from the non-operational position via a first pivoting motion to the operational position as shown in FIG. 4B and FIG. 4C followed by movement along a straight line with the clip 8 in the operational position for engagement with the worktop, see FIG. 4D.

When the screw 12 is rotated by means of the tool 84, the clip 8 will be pivoted until one of its peripheral straight edge surfaces 26 is brought in contact with its adjacent contact surface 46 of the spacer member 40, see FIG. 4C. The contact between the peripheral straight edge surface 26 and the contact surface 46 of the spacer member 40 defines and end stop for the pivoting movement of the clip 8. From that intermediate position, the clip 8 will travel along the screw 12 when the rotation of the screw is continued.

Turning now again to FIG. 2A, a sink arrangement 90 is shown, wherein the sink arrangement 90 comprises the sink 4 and a plurality of connection means 66 distributed around a periphery of the sink. The sink arrangement 90 further comprises a plurality of clip devices 2, wherein connection means 48 of each one of the plurality of clip devices 2 is adapted for connection to one of the plurality of connection means 66 of the sink. The clip devices 2 are arranged so that an engagement portion 22 of the respective clip 8 for engagement with the worktop 6 is in the retracted state proximate to the sink 4 and in the extended state distant to the sink 4.

It is to be understood that the present invention is not limited to the embodiments described above and illustrated in the drawings; rather, the skilled person will recognize that many changes and modifications may be made within the scope of the appended claims.

The worktop has above been described as formed in wood, wherein the engagement portion of the clip may penetrate the material of the worktop. According to an alternative, the worktop is formed in a material providing a relatively high hardness, such as stone or some composite materials, wherein the engagement portion of the clip may not penetrate the material of the workshop, but instead form a counter support underneath the worktop for bracing the sink to the worktop. Further, the clip has been described as formed in a metallic material, but also non-metallic materials, such as a plastic material may be used.

1. A clip device for securing a sink to a worktop, wherein the clip device is adapted for being connected to the sink, the clip device comprises:
a moveable clip that is adapted for engagement with the worktop, wherein the clip device is adapted for movement of the clip between a non-operational position, in which the clip is prevented from engagement with the worktop, and an operational position, in which the clip is allowed to engage with the worktop, wherein the clip is in a retracted state in the non-operational position and in an extended state in the operational position, wherein the non-operational position and the operational position are angularly spaced, wherein the clip device is adapted for maintaining the clip in the non-operational position so that the clip device may be connected to the sink during movement of the sink towards a desired position relative to an opening of the worktop and that the clip device is adapted for movement of the clip from the non-operational position towards the operational position when the sink is in the desired position relative to the worktop;
wherein the clip comprises two peripheral straight edge surfaces defining a first end stop in a first direction corresponding to the non-operational position and a second end stop in a second direction opposite the first direction corresponding to the operational position.

2. The clip device according to claim 1, wherein the clip is arranged to be pivoted between the non-operational position and the operational position.

3. The clip device according to claim 2, wherein the non-operational position and the operational position are angularly spaced by about 90°.

4. The clip device according to claim 1, wherein the clip device is adapted to guide the clip from the non-operational position via a first pivoting motion to the operational position followed by movement along a straight line with the clip in the operational position for engagement with the worktop.

5. The clip device according to claim 1, further comprising a screw adapted for moving the clip between the non-operational position and the operational position, wherein the clip has a threaded through-hole adapted for engagement with threads of the screw.

6. The clip device according to claim 5, wherein the clip further comprises a first leg and a second leg extending at an angle relative to the first leg, wherein the first leg of the clip has the threaded through-hole adapted for engagement with the screw and wherein a free end of the second leg has an engagement portion adapted for engagement with the worktop.

7. The clip device according to claim 6, wherein the first leg of the clip has two peripheral straight edge surfaces arranged at an angle relative to one another adjacent the through-hole and a rounded peripheral edge surface connecting the two peripheral straight edge surfaces, wherein the two peripheral straight edge surfaces define the first and second end stops.

8. The clip device according to claim 1, further comprising a support structure for connection to the sink, wherein a contact surface of the clip is adapted for engagement with a corresponding contact surface of the support structure for maintaining the clip in the non-operational position via friction between the contact surfaces.

9. The clip device according to claim 8, wherein the support structure comprises two spaced support members and a spacer member that connects the two spaced support members, wherein each support member has a through hole, which are in line with each other, wherein a screw is freely rotatably arranged in through-holes of the clip and wherein the clip is movably arranged between the two spaced support members.

10. The clip device according to claim 9, wherein the spacer member comprises a contact surface facing the clip and wherein the clip is arranged so that pivoting of the clip in one direction is stopped by one of two peripheral straight edge surfaces of a leg of the clip contacting the contact surface of the spacer member and pivoting of the clip in the other direction is stopped by the other one of the two peripheral straight edge surfaces contacting the contact surface of the spacer member.

11. The clip device according to claim 9, wherein a first leg of the clip has the contact surface and a first one of the two spaced support members has the corresponding contact surface for maintaining the clip in the non-operational position via friction between the contact surfaces.

12. The clip device according to claim 1, further comprising a projection for connection to a hole in the sink so that the clip device may hang from the sink.

13. A sink arrangement for securing a sink to a worktop, comprising:
the sink including a plurality of connection elements distributed around a periphery of the sink,
a plurality of clip devices according to claim 1, wherein connection elements of each one of the plurality of clip devices is adapted for connection to one of the plurality of connection elements of the sink, wherein an engagement portion of the clip for engagement with the worktop is in the retracted state proximate to the sink and in the extended state distant to the sink.

14. The sink arrangement according to claim 13, wherein the sink comprises a container and a rim extending around the container, wherein the plurality of clip devices are adapted to be connected to the sink below the rim with the clip in the non-operational position such that the engagement portions of the clips are spaced from a peripheral edge of the rim seen from above so that the sink may be lowered into an opening in the worktop while the plurality of clip devices are connected to the sink.

15. The sink arrangement according to claim 13, wherein the clip of at least one of the plurality of clip devices is arranged to be pivoted between the non-operational position and the operational position.

16. The sink arrangement according to claim 15, wherein the non-operational position and the operational position are angularly spaced by about 90°.

17. The sink arrangement according to claim 13, wherein at least one of the plurality of the clip devices is adapted to guide the clip from the non-operational position via a first pivoting motion to the operational position followed by movement along a straight line with the clip in the operational position for engagement with the worktop.

18. The sink arrangement according to claim 13, wherein the clip of at least one of the plurality of clip devices includes a first leg and a second leg extending at an angle relative to the first leg, wherein the first leg of the clip has a threaded through-hole adapted for engagement with a screw and wherein a free end of the second leg has the engagement portion adapted for engagement with the worktop.

19. The sink arrangement according to claim 18, wherein the first leg of the clip has two peripheral straight edge surfaces arranged at an angle relative to one another adjacent the through-hole and a rounded peripheral edge surface connecting the two peripheral straight edge surfaces, wherein the two peripheral straight edge surfaces define the first and second end stops.

20. The sink arrangement according to claim 13, wherein at least one of the plurality of clip devices includes a support structure for connection to the sink, wherein a contact surface of the clip of the at least one clip device is adapted for engagement with a corresponding contact surface of the support structure for maintaining the clip in the non-operational position via friction between the contact surfaces.
